(19) United States
(12) Patent Application Publication
(10) Pub. No.: US 2010/0238470 A1
(43) Pub. Date: Sep. 23, 2010

(54) DOCUMENT IMAGE PROCESSING SYSTEM AND DOCUMENT IMAGE PROCESSING METHOD

(76) Inventor: Naoaki KODAIRA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/725,291

(22) Filed: Mar. 16, 2010

(30) Foreign Application Priority Data
Mar. 17, 2009 (JP) P2009-063911

(51) Int. Cl. H04N 1/60; G06K 9/00; G06K 9/34

(52) U.S. Cl. 358/1.9; 382/167; 382/164

(57) ABSTRACT

A document image processing system is provided with an input portion to input a document image. An extraction portion extracts document elements of the document image from pixels of the inputted document image. A presumption portion presumes representative colors of the extracted document elements in a color space. A calculation portion calculated a plane to separate the presumed representative colors in the color space. A substitution portion substitutes colors of the pixels of each of the document elements existing in a region separated by the calculated plane in the color space with each of the representative colors existing in the same region.

### CROSS REFERENCE TO RELATED APPLICATION

This application is based upon and claims the benefit of priority from the prior Japanese Patent Application No. 2009-63911, filed on Mar. 17, 2009, the entire contents of which are incorporated herein by reference.

### FIELD OF THE INVENTION

The invention relates to a document image processing system, a document image processing method, and a document image processing program to perform subtraction processing on a document image.

### DESCRIPTION OF THE BACKGROUND

The JPEG (Joint Photographic Experts Group) format is well known as means to compress a color image at a high compression ratio. When a document image containing characters is compressed at a high compression ratio using the JPEG format, edge portions of the characters become blurred due to block noises so that visibility becomes poor. A known technique to eliminate the problem is to subtract colors of an original image when the original image is compressed.

Color subtraction techniques are disclosed in JP-H7-44709-A, JP-2007-116419-A, and JP-H5-67234-A. In JP-H7-44709-A, the number of colors to be used is determined by performing either a Hough transform or a main-component analysis on a frequency distribution in a color space. In addition, liner distributions of colors in the color space are acquired. The acquired distributions are classified into several clusters. Then, the several colors of the respective classified clusters are used to perform color subtraction.

In addition, in JP-2007-116419-A, the number of dimensions (colors) is calculated by performing a main-component analysis on a frequency distribution in a color space. Convex portions in the frequency-distribution region are determined by setting a parameter on the basis of the calculated number of colors. Pixel values are determined as color values of the colors used in an original document. The pixel values correspond to the determined convex portions respectively.

Further, in JP-H5-67234, local maximums are identified in a frequency distribution in a color space to extract only characters from an object to be read. Then, the local maximums are converted into directional vector data originating from the local maximum having the highest brightness, for example, the local maximum in the background color. The color of the characters is identified based on a result of classification of the vector data. Subsequently, two local maximums of a pattern (a design portion) other than the characters and the local maximum of the background color are used to define a plane. The distance to the plane from the vector of the color of the characters is calculated by projecting the vector on the plane by using a straight line perpendicular to the plane. The characters are separated from the design portion or the background by the calculated distance.

Images of edge portions of the characters, however, are more likely to have colors different from the color of the actually used ink, due to color shift that occurs at the time of scanning and the like. For example, the edge portions may have an intermediate color due to an influence of both the ink color and the background color. In this case, the technique disclosed in JP-H7-44709-A, which does not show a definite processing for the color deviating from the linear distribution, cannot handle the intermediate color appropriately.

A document image of ledger sheets or the like, sometimes, has a particular field intentionally dotted to be colored with an intermediate color. In addition, in some cases, some characters are printed over the halftone dots using an ink of the same color as that of the halftone dots. In this case, the technique mentioned in JP-2007-116419-A may have the following problem. If the color substitution processing of the document image is performed, the characters and the halftone dots may be recognized as having the same color so that the characters may be difficult to read. Further, when an image is read from a document, on which characters or ruled lines of a red color are printed previously and on which a seal impression of a vermilion color is below added, the JP-2007-116419-A has difficulty in classifying the red color of the characters or ruled lines and the vermilion color into different color clusters.

Furthermore, in the JP-H5-67234-A, it is necessary to define a plane using the local maximums for the design portion and the local maximum for the background color. For this reason, in the JP-H5-67234-A, the number of colors in use needs to be known in advance, and additionally, when a large number of colors other than the color of the characters are used, it may be impossible to define the above-mentioned plane.

Accordingly, in the techniques disclosed in JP-H7-44709-A, JP-2007-116419-A, and JP-H5-67234-A, it is difficult to perform effective color subtraction processing on a general document image.

### SUMMARY OF THE INVENTION

The invention has been made to eliminate the above problems, and an advantage of an aspect of the invention is to provide a system, a method, and a program for processing document image which are capable of performing color subtraction processing by appropriately substituting colors of pixels of a document image with a representative color.

An aspect of the present invention provides a document image processing system, which includes an input portion to input a document image, an extraction portion to extract document elements of the document image from pixels of the inputted document image, a presumption portion to presume representative colors of the extracted document elements in a color space, a calculation portion to calculate a plane to separate the presumed representative colors in the color space, and a substitution portion to substitute colors of the pixels of each of the document elements existing in a region separated by the calculated plane in the color space with each of the representative colors existing in the same region.

Another aspect of the present invention provides a document image processing method, which includes inputting pixels of a document image, extracting document elements of the document image from the inputted pixels of the document image, presuming representative colors of the extracted document element in a color space, calculating planes to separate the presumed representative colors in the color space, and substituting colors of the pixels of each of the document elements existing in each separation region of the color space with each of the representative color existing in the same separation region, the separation region being separated by at least one of the calculated planes.

The invention makes it possible to appropriately substitute colors of pixels of color images of a document, on which characters and images other than the characters are printed, with representative colors.

### BRIEF DESCRIPTION OF THE DRAWINGS

FIG. 1 is a diagram illustrating a configuration of a document image processing system according to a first embodiment of the invention.

FIG. 2 is a diagram illustrating a functional configuration of a CPU shown in FIG. 1 according to the first embodiment.

FIG. 3 is a diagram illustrating an example of a document image to be inputted into a document image input portion shown in FIG. 2.

FIG. 4 is a flowchart illustrating an example of processing being performed by a document element extraction portion shown in FIG. 2.

FIG. 5 is a diagram illustrating an example of a binary image being created by performing a binarization processing on the inputted document image shown in FIG. 3.

FIG. 6 is a diagram illustrating an example of result of extracting black pixels that are identified as character regions from the binary image shown in FIG. 5,

FIG. 7 is a diagram illustrating an example of result of extracting, black images that are identified as ruled-line regions from the binary image shown in FIG. 5.

FIG. 8 is a diagram illustrating an example of frequency distributions to explain a concept of processing performed by a representative color presumption portion shown in FIG. 2.

FIG. 9 is a diagram illustrating an example of frequency distributions together with a binarization plane and vectors drawn from a frequency distribution of a background color to the other frequency distributions.

FIG. 10 is a diagram illustrating a case where the frequency distributions shown in FIG. 9 are divided by the binarization plane into an upper plane and a lower plane.

FIG. 11 is a diagram illustrating an example of frequency distribution to explain a processing being performed by a separation plane calculation portion.

FIG. 12 is a diagram illustrating an example of frequency distribution in which the color distribution shown in FIG. 11 is projected to a vector between representative colors.

FIG. 13 is a drawing illustrating an example of frequency distribution to explain a situation in which plural separation planes are calculated.

FIG. 14 is a diagram illustrating another functional configuration of the CPU shown in FIG. 1 according to a second embodiment.

### DETAILED DESCRIPTION OF THE INVENTION

Hereinafter, embodiments of the invention will be described with reference to the drawings. In the drawings, the same reference numerals denote the same or similar portions respectively.

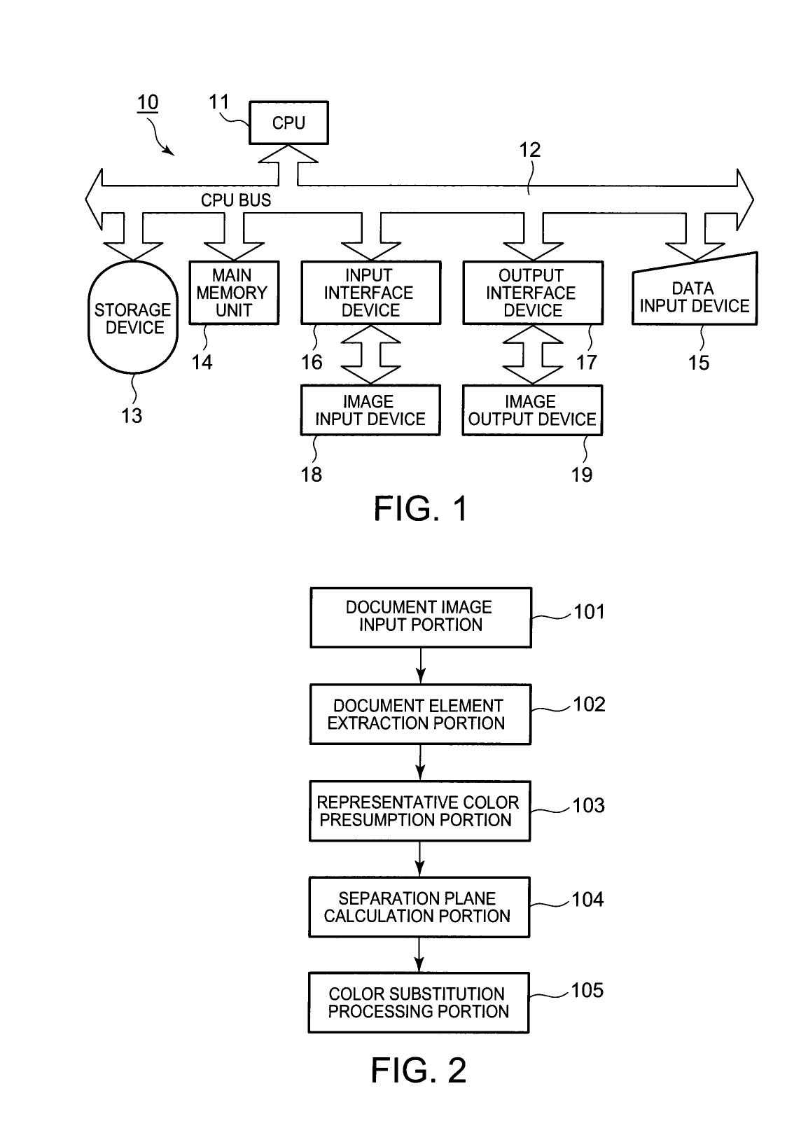

FIG. 1 is a diagram illustrating a configuration of a document image processing system according to a first embodiment of the invention.

A document image processing system 10 is provided with a CPU 11, a CPU bus 12, a memory device 13, a main memory portion 14, a data input device 15, an input interface device 16, an output interface device 17, an image input device 18, an image output device 19. The CPU 11, the CPU bus 12, the memory device 13, the main memory portion 14, the data input device 15, the input interface device 16 and the output interface device 17 compose a computer.

The CPU 11, the memory device 13, the main memory portion 14, the data input device 15, the input interface device 16 and the output interface device 17 are connected to one another through the CPU bus 12.

The memory device 13 is a working memory for the CPU 11. The memory device 13 is formed of such a device as a magnetic disc drive or a semiconductor memory. The main memory portion 14 includes a program storage area and a temporary memory area. A document image processing program can be stored in the program storage area. The document image processing program controls the document image processing system 10. The temporary memory area is used for the CPU 11. The main memory portion 14 is formed of a device such as a semiconductor memory. The document image processing program is stored in the memory device 13, and is loaded to the main memory portion 14 from the memory device 13 when the document image processing system 10 is booted.

The data input device 15 is formed of an equipment such as a keyboard or a mouse. Data or instructions are inputted in response to operations performed by an operator. The input interface device 16 is connected to the image input device 18. The image input device 18 is a scanner device to read a document on which characters and images of ruled lines, graphics and photos other than the characters are printed. The input interface device 16 inputs a document image data read by the image input device 18. The document image data are sent to the memory device 13 through the CPU bus 12, and are stored in the memory device 13.

The output interface device 17 is connected to the image output device 19. The output interface device 17 receives the document image data stored in the memory device 13 through the CPU bus 12, and outputs the received document image data to the image output device 19. The image output device 19 is a device which outputs the document image data received through the output interface device 17, and is, for example, a display device, a printing device or a filing device.

FIG. 2 is a diagram illustrating the functional configuration of a CPU shown in FIG. 1 according to the first embodiment.

The CPU 11 performs an overall control over the document image processing system 10. The CPU 11 includes a document image input portion 101, a document element extraction portion 102, a representative color presumption portion 103. The CPU 11 further includes a separation plane calculation portion 104, and a color substitution processing portion 105. The document image input portion 101, the document element extraction portion 102, the representative color presumption portion 103, the separation plane calculation portion 104, and the color substitution processing portion 105 represent operation functions respectively being performed when the CPU 11 executes the document image processing program.

The document image input portion 101 reads and receives the document image data sent from the input interface device 16 to the memory device 13 and stored in the memory device 13. The document image input portion 101 functions as an input portion which receives document image data. The document image data are color image data being read by a scanner device.

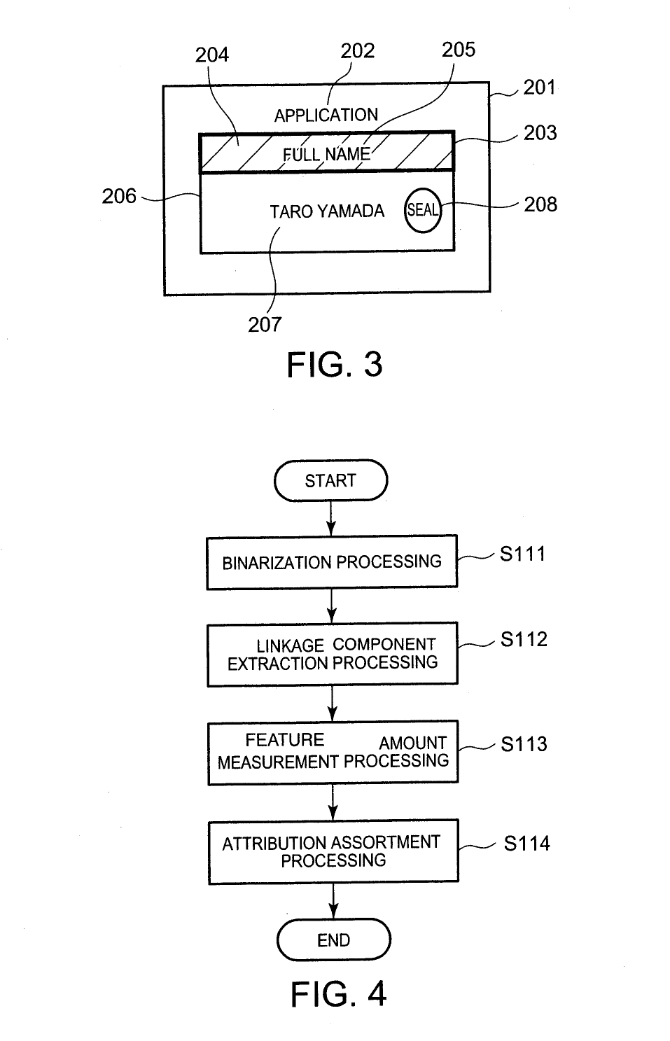

FIG. 3 is a diagram illustrating an example of a document image 201, which is image data of a color document to be inputted into a document image input portion 101 shown in FIG. 2. For example, the document image 201 includes a background having a white color, a character “Application” 202 having a red color, a thick-line frame 203 having a blue color, a halftone-dotted portion 204 having a light blue color, characters “Full Name” 205 having a blue color, a ruled-line frame 206 having a black color, written-in characters “Toshiba Taro” 207 having a black color, and a seal 208 having a vermilion color. These may be displayed on a sheet by printing or handwriting. The seal 208 has a smaller number of pixels than each of the other, different-colored portions.

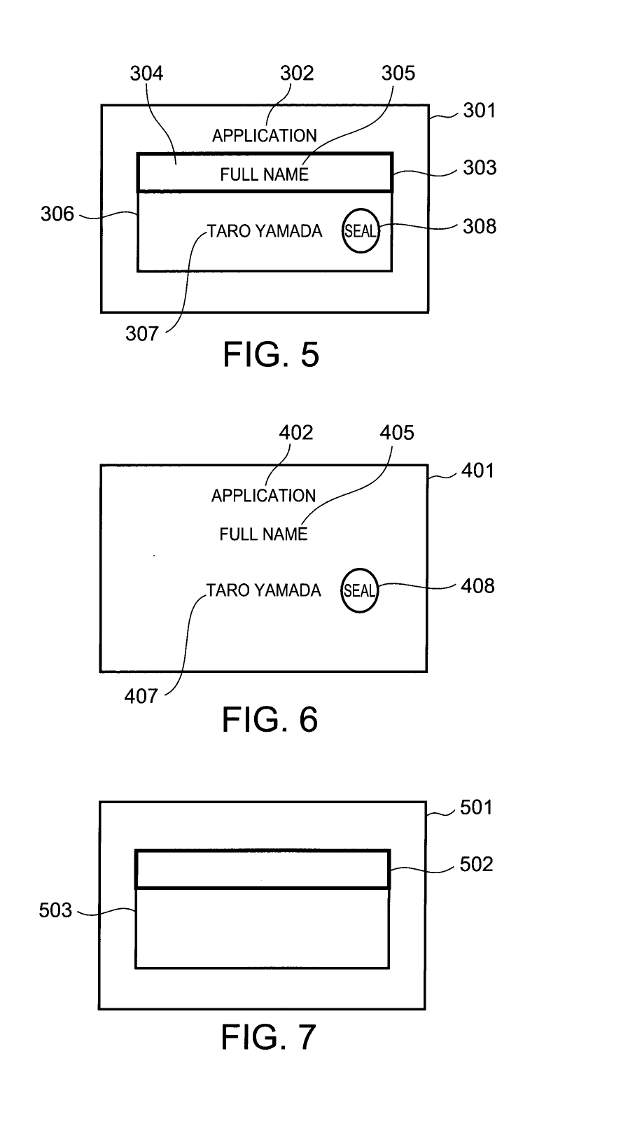

The document element extraction portion 102 shown in FIG. 2 extract document elements, such as characters and ruled lines, from the document image 201 inputted into the document image input portion 101. FIG. 4 is a flowchart illustrating an example of processing performed by the document element extraction portion 102 shown in FIG. 2. The document element extraction portion 102 performs binarization processing, linkage component extraction processing, feature amount measurement processing, and attribute classification processing. Hereinafter, these types of processing will be described in detail with reference to FIGS. 5 to 9.

### (Binarization Processing)

The document element extraction portion 102 performs binarization processing as pre-processing (step S111 in FIG. 4). In this identification of document elements, such dark colors as to make the elements distinguishable from the background are important in general. Accordingly, noises and halftone-dotted areas are removed to create a binary image including white pixels and black pixels through the binarization processing performed by the document element extraction portion 102. In order to perform the binary image creation, commonly known techniques are available. For example, a discriminant analysis method, in which an optimum threshold is obtained when a grayscale image is subjected to binarization processing, may be used.

FIG. 5 is a diagram illustrating an example of a binary image 301 created by performing binarization processing on the document image 201 shown in FIG. 3. The binary image 301 shown in FIG. 5 includes a black-pixel group 302 corresponding to the character group “Application” 202 shown in FIG. 3. Further, the binary image 301 includes a black-pixel group 303 corresponding to the thick-line frame 203, a black-pixel group 305 corresponding to the character group “Full Name” 205, a black-pixel group 306 corresponding to the ruled-line frame 206, a black-pixel group 307 corresponding to the written-in characters “Taro Yamada” 207, and a black-pixel group corresponding to the seal 208. However, the halftone-dotted portion 204 shown in FIG. 3 has a light color so that the corresponding portion in FIG. 5 becomes a blank 304.

### (Linkage Component Extraction Processing)

The document element extraction portion 102 performs linkage component extraction processing (step S112 in FIG. 4) on the binary image 301 created through the binarization processing. In the linkage component extraction processing, the connectivity of black pixels is detected and those black pixels that are connected to each other are extracted as a block.

### (Feature-Amount Measurement Processing)

Then, feature amounts, such as “size,” “shape,” “black-pixel proportion,” and “black-pixel distribution,” are measured with respect to each of the extracted linkage components (step S113 in FIG. 4). For example, in order to measure the “size,” a circumscribed rectangle to the linkage component is assumed, and the numbers of pixels arranged in the length side and in the width side of the rectangle are measured. In order to measure the “shape,” it is identified whether the shape of the circumscribed rectangle is close to a square or has an elongated shape in the width direction, for example. In order to measure the “black-pixel proportion,” the proportion of the black pixels to the area of the circumscribed rectangle to the linkage component is measured. In order to measure the “black-pixel distribution,” it is measured whether the black pixels are uniformly distributed or not uniformly distributed within the circumscribed rectangle to the linkage component.

Using the measurement results of the feature amount measurement processing, an attribute classification is performed to determine what kind of document element each linkage component is (step S114 in FIG. 4). For example, if a document element has a “size” that is smaller than the size of the document image, has a “shape” that is close to a square and has a high “black-pixel proportion,” the document element is identified as a character. If a document element has a “size” that is larger than a character, has a blank internal space, has a low “black-pixel proportion” and a “black-pixel distribution” characterized by the existence of black pixels only in the vicinity of the circumscribed-rectangle perimeters to the linkage component, the document element is identified as a ruled-line frame. If a linkage component is extracted as a character, the linkage component may be identified as a character only on condition that there is another similar linkage component in the peripheral area. Such a way of identification of characters can remove noise components generated at the time of binarization.

FIG. 6 is a diagram illustrating an example result of extracting only black pixels, which are identified as character regions of the character image 401, from the binary image 301 shown in FIG. 5 The document element extraction portion 102 extracts “Application” 402, “Full Name” 405, written-in characters “Taro Yamada” 407, and a seal 408, as characters of the character image 401. The character image 401 is only an illustration showing the overall size of the document image, for convenience. Thus, the character image 401 is not the results of extraction performed by the document element extraction portion 102.

FIG. 7 is a diagram illustrating an example result of extracting only black images, which are identified as ruled-line regions of the ruled-line image 501, from the binary image 301 shown in FIG. 5. The document element extraction portion 102 extracts a thick-line frame 502 and a ruled-line frame 503 as the ruled-line image 501. As in the case of the character image 401, the ruled-line image 501 is only an illustration showing the overall size of the document image, for convenience. Thus, the ruled-line image 501 is not the results of extraction performed by the document element extraction portion 102. The document element extraction portion 102 functions as an extraction portion to extract document elements of the document image from the pixels of the inputted document image.

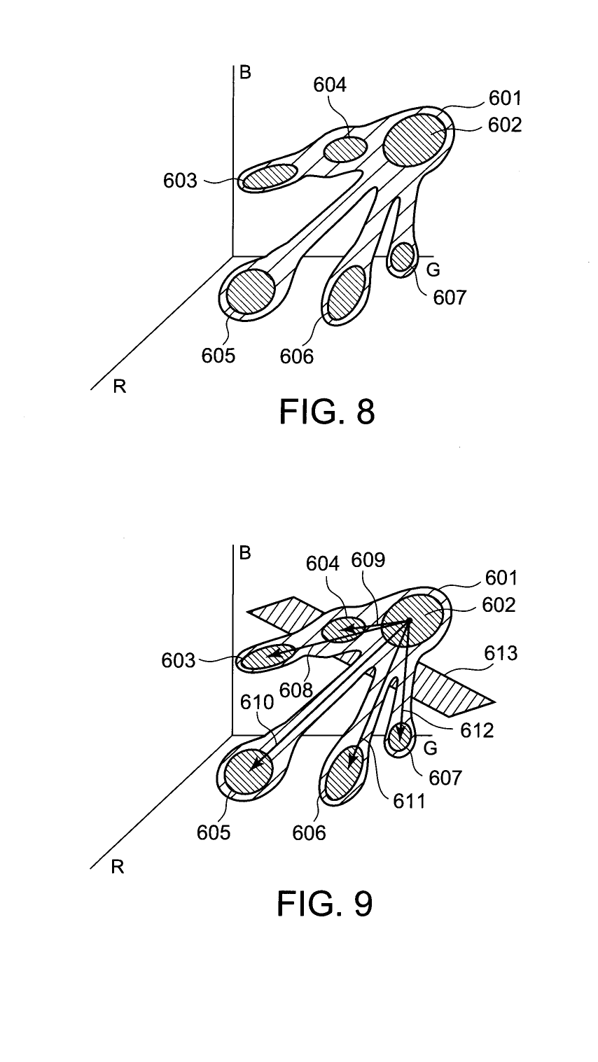

The representative color presumption portion 103 shown in FIG. 2 presumes the colors of the pixels of the extracted document elements, such as the characters and the ruled lines, and the colors of the pixels of background. To this end, the representative color presumption portion 103 uses the frequency distributions in the color space. FIG. 8 is a diagram illustrating an example of a frequency distribution 601 to explain a concept of the processing performed by the representative color presumption portion 103 shown in FIG. 2. Three-dimensional frequency distributions are acquired using the document image 201 shown in FIG. 3 as the document image data to be inputted. To this end, the color values of the pixels are expressed by the RGB color model. The frequency distributions for all the pixels in the document image 201 to be inputted are acquired and plotted to obtain the frequency distribution 601 shown in FIG. 8.

The frequency distribution 601 includes a frequency distribution for a white-colored background (hereafter referred to as “frequency distribution for a background color”) 602, a frequency distribution for blue-colored characters and for ruled lines 603, a frequency distribution for light-blue-colored halftone dots 604, a frequency distribution for black-colored characters and ruled lines 605, a frequency distribution for red-colored characters 606, and a frequency distribution for a vermilion-colored seal 607.

The frequency distributions shown in FIG. 8 correspond to the portions of the document image 201 shown in FIG. 3, as follows. The frequency distribution for a background color 602 corresponds to the background color. The frequency distribution for blue-colored characters and ruled lines 603 corresponds to the thick-line frame 203 and the characters “Full Name” 205. The frequency distribution for light-blue-colored halftone dots 604 corresponds to the halftone-dotted portion 204. The frequency distribution for black-colored characters and ruled lines 605 corresponds to the ruled-line frame 206 and the written-in characters “Toshiba Taro” 207. The frequency distribution for the red-colored characters 606 corresponds to the character group 202. The frequency distribution for the vermilion-colored seal 607 corresponds to the seal 208.

Frequency distributions for various intermediate colors expand in the areas located between the frequency distribution 602 for a background color and the frequency distributions 603 to 607. The frequency distribution 601 can be considered as one including these intermediate colors. In practice, there are pixels having RGB values outside the frequency distribution 601. Detailed description of these pixels will be given below. In each of the frequency distributions 603 to 607, the RGB value located approximately at the center has the highest frequency. Accordingly, each of the vectors can be considered as the representative color of the corresponding frequency distribution by defining vectors from the frequency distribution for a background color 602 to the frequency distributions 603 to 607 respectively.

Each of the frequency distributions 603 to 607 can be obtained from the region extracted as the corresponding document element alone. In this case, such a vastly-expanded region as the frequency distribution 601 is not produced. The representative color presumption portion 103 functions as a presumption portion to presume the representative colors for the corresponding extracted document elements in the color space.

FIG. 9 is a diagram illustrating example frequency distributions together with a binarization plane 613 and vectors 608 to 612 drawn from the frequency distribution for a background color 602 to the corresponding one of the frequency distributions 603 to 607. The frequency distributions 601 to 607 shown in FIG. 9 are the same as those described in FIG. 8. The vectors 608 to 612 are the representative vectors of the frequency distributions 603 to 607 respectively. The end points of the representative vectors 608 to 612 are the RGB values which have the highest frequencies in the frequency distributions 601 to 607.

In the case of this embodiment, it is assumed that the representative vectors 608 to 612 are calculated from the frequency distribution 601 of the document image. In this case, the representative vector of each frequency distribution can be calculated by obtaining the local maximum values for the frequency distributions. However, there may be problems associated with intermediate colors. When intermediate colors exist as in the frequency distribution 604, the frequency distribution extends in a horizontal direction. In addition, the distance between the frequency distribution 604 and the frequency distribution 603 is short. Accordingly, the frequency distribution may be influenced by the frequency distribution 603. Conversely, the calculation of the representative vector 608 of the frequency distribution 603 may be incorrect due to the influence of the frequency distribution 604.

The frequency distribution for a vermilion color 607 has the smaller number of pixels than each of the other frequency distributions 602 to 606. Thus, the representative vector 612 cannot be calculated correctly in some cases of particular extension from the frequency distribution for a background color 602. If the calculated representative vector 612 is incorrect, the separation plane calculation portion 104 cannot calculate a correct separation pbelowesulting in a less visible image. Detailed description for the separation plane calculation portion 104 will be given below.

In order eliminate this problem, the representative vectors for important document elements, such as characters and ruled lines, are calculated not from the entire frequency distribution in this embodiment. Instead, the representative vectors are determined by separating the colors of such important document elements from the background color and from the intermediate colors. To this end, the embodiment uses the results of the binarization processing and of the document element extraction performance, both of which are performed by the document element extraction portion 102.

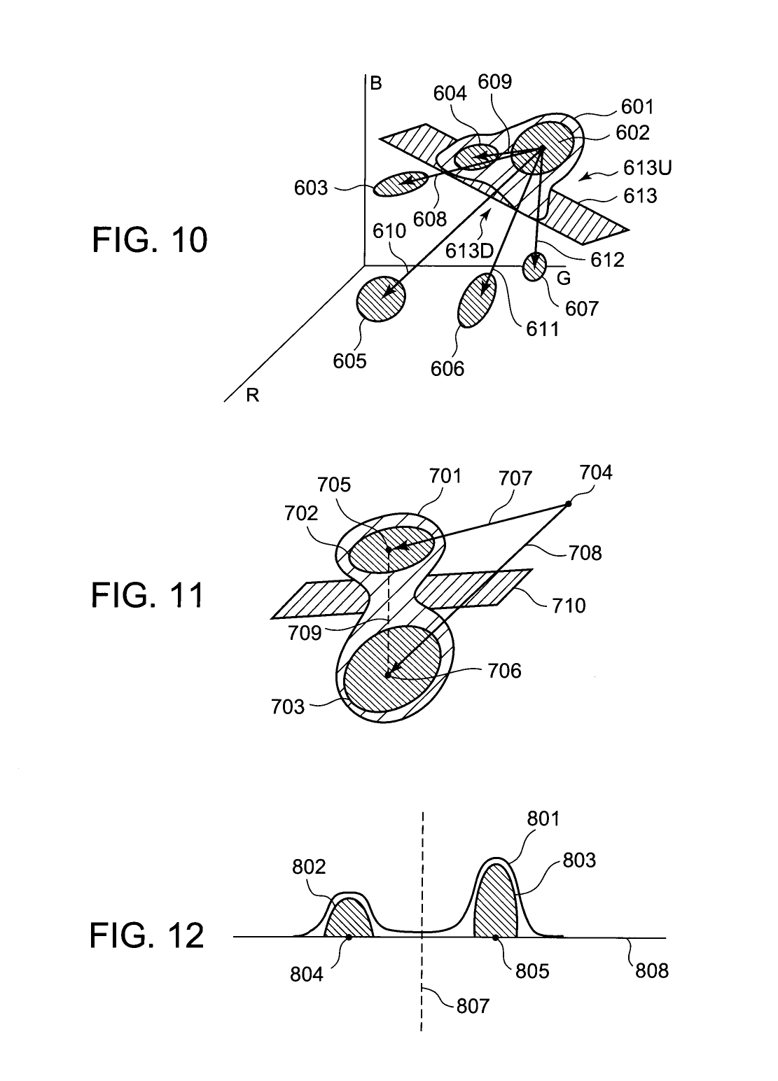

FIG. 10 is a diagram illustrating an example case where the frequency distributions 601 shown in FIG. 9 are divided by the binarization plane 613 into an upper plane 613 U and a lower plane 613D. Dividing the frequency distribution 613 into the upper plane 613U and the lower plane 613D means binarization processing performed in the color space in the RGB model. The upper plane 613U is a light-colored region for the background, whereas the lower plane 613D is a dark-colored region for document elements such as characters and ruled lines. Among the frequency distributions existing in the upper plane 613U, the frequency distribution for a background color 602 has a local maximum (RGB value) which is significantly larger than the local maximum of the frequency distribution for light-blue-colored halftone dots 604. The much larger local maximum allows the frequency distribution for a background color 602 to be presumed as the representative color of the background color, which serves as the reference for the representative vectors. Subsequently, the local maximum of the frequency distribution for light-blue-colored halftone dots 604, which is supposed to have the next local maximum, is obtained, and the obtained local maximum is determined as the representative color for the frequency distribution 604.

Subsequently, the local maximums of the frequency distributions 603 and 605 to 607 existing in the lower plane 613D are obtained to determine the representative colors for the frequency distributions 603 and 605 to 607. The representative colors are not determined on the basis of the overall frequency distribution. Instead, each representative color is determined on the basis of the frequency distribution using the results of extracting document elements. Specifically, the representative colors are obtained individually on the basis of the frequency distribution for blue-colored characters and ruled lines 603, the frequency distribution for light-blue-colored halftone dots 604, the frequency distribution for black-colored characters and ruled lines 605, the frequency distribution for red-colored characters 606, and the frequency distribution for a vermilion-colored seal 607. The representative colors thus obtained are not affected by the extension of the distribution. Thus, the representative colors can be determined correctly. The technique disclosed in JP-H5-61974-A may be used as a specific method of calculating representative vectors. According to the technique, when the RGB data on the document image are inputted, local maximums are detected by creating a density histogram. Then, the calculation of representative vectors are achieved by converting the local maximums detected into directional-vector data on the local maximums from the reference point set at the background color.

The separation plane calculation portion 104 shown in FIG. 2 calculates a plane to separate representative colors in the color space. FIG. 11 is a diagram illustrating example frequency distributions to explain the processing performed by the separation plane calculation portion 104. In the color space shown in FIG. 11, a frequency distribution 701 exists, and the frequency distribution 701 includes distributions for two colors, which are a frequency distribution 702 and a frequency distribution 703. For example, the frequency distribution 702 corresponds to the frequency distribution 604 in FIG. 10, whereas the frequency distribution 703 corresponds to the frequency distribution 603 in FIG. 10.

The colors of the frequency distributions 701 to 703 are the colors of the document elements, such as the characters, the ruled lines and the light-blue-colored halftone dots. The representative colors of the frequency distributions 702 and 703 will be referred to as a representative color 705 and a representative color 706, respectively. In addition, the representative color of the background color will be referred to as a representative color 704. The frequency distribution 602 shown in FIG. 10 may be an example frequency distribution for the background color. In this example, the frequency distributions 702 and 703 are of different colors, but are not separated from each other completely as shown in the frequency distribution 701.

FIG. 10 does not show the frequency distributions which exist somewhere between the above-mentioned representative colors. It is, however, often the case that such distributions exist actually. This phenomenon may occur if characters of one color and ruled lines of a different color exist or if characters and rules lines exist so as to be in contact with each other. In this state, when the color substitution processing portion 105, which will be described in detail below, can not determine which one of the representative colors should be used when it substitutes the colors of the pixels with a representative color. Accordingly, a separation plane 710 between the frequency distributions of the two colors is calculated. All the pixels having RGB values located above the separation plane 710 can be substituted with the representative color 705. Similarly, all the pixels having RGB values located below the separation plane 710 can be substituted with the representative color 706. The separation plane calculation portion 104 functions as a calculation portion to calculate the separation plane 710 which separates the presumed representative colors in the color space.

A specific way of calculating the separation plane 710 will be described. Representative vectors 707 and 708 of two colors are obtained from the representative color 704 of the background color and the representative colors 705 and 706 of the respective frequency distributions 702 and 703. Then, a vector 709 between the two colors is obtained. The directional vector for the vector 709 is assumed to be expressed as (a, b, c). If the separation plane 710 is perpendicular to the vector 709, the normal vector to the separation plane 710 is expressed also as (a, b, c). Accordingly, the separation plane 710 is expressed by the following equation (1).

ax+by+cz+d=0 (1)

How to obtain the coefficient d will be described. FIG. 12 is a diagram illustrating an example of frequency distributions, in which the distributions between the two colors shown in FIG. 11 are projected to a vector between the representative colors. The vector 709 in FIG. 11 corresponds to a projection axis 806. The representative colors 705 and 706 in FIG. 11 correspond respectively to distributions 804 and 805 after the projection. The frequency distributions 701 to 703 in FIG. 11 correspond respectively to the projection distributions 801 to 803. The projection distributions 801 to 803 are used to calculate a separation plane 807. As in the case of the binarization processing, a well known discrimination analysis method may be used as the calculation method. As a consequence of the calculation, a coordinate value (α, β, γ) of the separation plane 807 on the projection axis 806 is calculated. By assigning the coordinate value to the equation (1), the coefficient d can be obtained. With the obtained coefficient d, the separation plane 710 in the color space shown in FIG. 11 can be calculated. Specifically, the coefficient d is following.

d=−(aα+bβ+cγ).

In practice, the separation plane calculation portion 104 calculates a separation plane between every two representative colors. To put it differently, the separation plane between every two adjacent representative colors is calculated, and the separation of representative colors is performed using the regions surrounded by the calculated planes. For example, a separation plane is calculated between every two of the frequency distributions 603, 605, 606, and 607 shown in FIG. 10, and the a representative color is determined for each of the regions surrounded by the separation planes.

Specifically, a positive (+) side and a negative (−) are defined with respective to each separation plane, and then whether the coordination value of a particular representative color is on the positive or the negative side is identified. If the representative color is on the positive side, the coordination values for all the colors existing on the positive side are acquired. Similar operations are performed for all the separation planes, and the region surrounded by the separation planes becomes the region corresponding to the representative color. In this event, to reduce the computation costs, the distance between every two representative colors may be calculated first, and if the representative colors are so remotely separated from each other that the calculated distance is equal to or larger than a predetermined threshold, the separation plane between those remote representative colors does not have to be calculated.

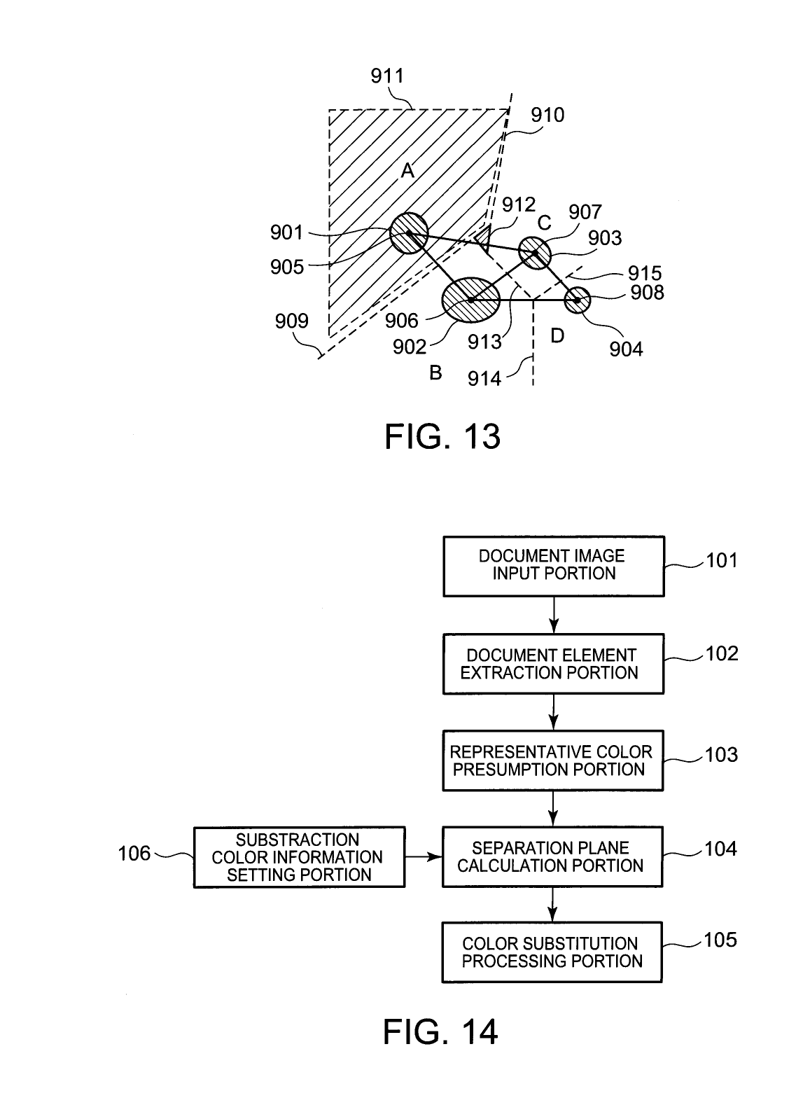

FIG. 13 is a drawing illustrating example frequency distributions to explain a situation in which plural separation planes 909, 910, and 913 to 915 are to be calculated. FIG. 13 is a diagram seen from the side of the origin point for the RGB axes in FIG. 8. In other word, the diagram is one seen from the black-color side. FIG. 13 show a frequency distribution for blue-colored characters and ruled lines 901 and a representative color 905 for the frequency distribution 901, a frequency distribution for black-colored characters and ruled lines 902 and a representative color 906 for the frequency distribution 902, a frequency distribution for red-colored characters 903 and a representative color 907 for the frequency distribution 903, and a frequency distribution for vermilion-colored seal 904 and a representative color 908 for the frequency distribution 904.

The portions shown in FIG. 13 correspond respectively to the portions show in FIG. 8 in the following way. The blue-color frequency distribution 901 is the region for the frequency distribution 603. The black-color frequency distribution 902 is the region for the frequency distribution 605. The red-color frequency distribution 903 is the region for the frequency distribution 606. The vermilion-color frequency distribution 904 is the region for the frequency distribution 607.

When separation of the blue-color frequency distribution 901 is performed, for example, the separation plane 909 is calculated by using the frequency distribution 901 with the representative color 905 and the black-color frequency distribution 902 with the representative color 906. Similarly, the separation plane 909 is calculated by using the blue-color frequency distribution 901 with the representative color 905 and the red-color frequency distribution 903 with the representative color 907. The blue-color frequency distribution 901 and the vermilion-color frequency distribution 904 are so remotely separated away from each other that the separation plane located between the distributions isl not be calculated. This is because, even if the separation plane between the frequency distribution 901 and the frequency distribution 904 is actually calculated, the calculated separation plane is located outside the separation planes 909 and 910 when seen from the representative color 905. A region 911 is formed as a region surrounded by the separation planes 909 and 910. The formed region 911 is a blue-color region A.

In addition, the separation plane 913 is calculated by using the black-color frequency distribution 902 with the representative color 906 and the red-color frequency distribution 903 with the representative color 907. Moreover, the separation plane 914 is calculated by using the black-color frequency distribution 902 with the representative color 906 and the vermilion-color frequency distribution 904 with the representative color 908. Furthermore, the separation plane 915 is calculated by using the red-color frequency distribution 903 with the representative color 907 and the vermilion-color frequency distribution 904 with the representative color 908.

If, in the separation of the black-color frequency distribution 902, the distance between the representative color 906 and each of the other three representative colors 905, 907, and 908 is equal to or shorter than a predetermined threshold, the separation planes 909, 913, and 914 may be calculated and then the region surrounded by these separation planes 909, 913, and 914 may be determined as a black-color region B. Similar way of determining vermilion-color region may be employed in the case of the separation of the vermilion-color frequency distribution 904. Though not illustrated in FIG. 12, the white-color side is separated by the binarization plane 613 shown in FIG. 10.

Accordingly, in practice, the blur-color region A is a region surrounded by three planes including the separation planes 909 and 910 calculated in the above-described way and the binarization plane 613. Similarly, the black-color region B is a region surrounded by four planes including the separation planes 909, 913, and 914 calculated in the above-described way and the binarization plane 613. Further, similarly, a red-color region C is a region surrounded by four planes including the separation planes 910, 913, and 915, and the binarization plane 613. In the same way, a vermilion-color region D is a region surrounded by three planes including the separation planes 914 and 915, and the binarization plane 613.

As described with reference to FIG. 13, the color substitution processing portion 105 shown in FIG. 2 substitutes the pixel areas of the inputted document image with representative colors presumed by the representative color presumption portion 103. Specifically, the color substitution processing portion 105 treats the RGB values of the pixels as points in the color space. Then, the color substitution processing portion 105 detects which of the representative colors each of the points is classified into by the separation planes calculated through the separation plane calculation processing. The color substitution processing portion 105 substitutes each of the points with the corresponding representative color. The color substitution processing portion 105 functions as a substitution portion to substitute the color of the pixel area of the document element existing in each separate region in the color space separated by the planes calculated in the above-described way, with the representative color existing in the same separation region.

When the color substitution processing portion 105 performs separation with the separation planes, regions, which belong to none of the regions of representative colors, may be generated in some cases. A region 912 shown in FIG. 13 is an example of such regions. If pixels exist in the region 912, what may be done is not a search for the representative color using the separation planes. Rather, the pixels may be substituted with a representative color identified by checking the peripheral pixels of the substituted document image. Specifically, if a target pixel belongs to none of the representative colors, the pixels located around the target pixel in the eight directions, i.e., pixels located above, below, at the right side of, at the left side of, at the upper-left side of, at the lower-right side of, at the upper-right side of, at the lower-left side of the target pixel may be checked to find out the most frequent representative color. Then, the most frequent representative color may be used as the representative color of the target pixel. The above-described processing is performed on all the pixels in the inputted document image, and thus the substitution of the pixels with representative colors, i.e., the color subtraction processing, is finished. Some pixels are identified as ones having intermediate colors and the background color in the binarization processing. Such intermediate-color and background-color pixels may be substituted with white color. A document image having only the representative colors and white of the background is generated through the above described processing. The document image is then subjected to compression processing so as to generate an image that is expected to be compressed at higher compression ratio.

The color substitution processing portion 105 creates a color map (RGB values) corresponding to the calculated representative colors and uses the color map as a basis of the color substitution, for example. The pixels substituted with the representative colors are stored as a bit map in the memory device 13.

According to the embodiment, document elements, such as characters and ruled lines, are extracted from a document image. Then, representative colors, and a binarization plane and separation planes among the representative colors are acquired. Subsequently, all the pixels existing in each one of the regions surrounded by the binarization plane and the separation planes are substituted with the representative color of the same one of the regions. Accordingly, the colors of the respective pixels in the document image can be appropriately substituted with the representative colors. Thus, effective color subtraction processing is accomplished without impairing visibility. What is made possible consequently is creation of a document image which has colors subtracted through compression processing at a high compression ratio.

FIG. 14 is a diagram illustrating another functional configuration of the CPU 11 of FIG. 1 according to a second embodiment. Processing performances of the document image input portion 101 to the representative color presumption portion 103 in the second embodiment are the same as those performed in the first embodiment shown in FIG. 2.

In the second embodiment, a subtraction color information setting portion 106 is provided as a functional configuration. The subtraction color information setting portion 106 sets a parameter to inform the separation plane calculation portion 104 of colors for the color subtraction processing. In the first embodiment, intermediate colors are removed through the color subtraction processing. When some users need to keep one or more intermediate colors, the subtraction color information setting portion 106 makes it possible to designate not only the blue color, the black color, the red color, and the vermilion color but also the intermediate color, i.e., a light-blue color.

In order to perform such a designation, designation information may be stored in a file and be read from the file. If the document image processing system 10 supports the graphical user interface (GUI), the designation may be done using the GUI. The designation information may be presented by giving a flag indicating whether or not a color other than the background color and being lower than the binarization threshold is allowed to be used as a representative color. The subtraction color information setting portion 106 functions as a portion to set up the colors of the extracted document elements.

In order to keep the intermediate color set up by the subtraction color information setting portion 106, the separation plane calculation portion 104 calculates separation planes even at the upper plane side (background side) located above the binarization plane 613.

The calculation processing will be described below by referring to FIG. 9. In FIG. 9, the representative color presumption portion 103 calculates the representative color and the representative vector 609 of the light-blue-color halftone-dotted portion 604. The separation plane to separate the frequency distribution 604 is calculated between the frequency distribution 604 and the frequency distribution of a background color 602. According to this calculation, the representative vector 707 shown in FIG. 11 is regarded as the representative vector 609 of FIG. 9, then projection distributions such as ones shown in FIG. 11 are obtained. As a result, a separation plane is obtained. The separation plane calculation portion 104 functions as a calculation portion to calculate planes to separate a particular one of the presumed representative colors in the color space, on the basis of the set-up colors.

In the example shown in FIG. 8, there is only one intermediate-color frequency distribution. If plural intermediate-color frequency distributions exist, the representative color and the representative vector of each intermediate-color frequency distribution are calculated. Thus, separation planes between intermediate colors can be obtained as in the case shown in FIG. 12. As a result of the processing described above, a document image with intermediate colors can be created.

In the embodiment, the subtraction color information setting portion 106 is used to keep one or more intermediate colors. It is possible to give an instruction to limit the number of representative colors constituting the document elements on the lower plane side of the binarization plane 613, in the state shown in FIG. 9. For example, if an instruction to limit the number of representative colors to three (3) is given, only the representative colors of the highest local maximum, the second highest local maximum, and the third highest local maximum are left among all the representative colors, which are presumed by the representative color presumption portion 103. By the processing, planes to separate particular representative colors in the color space can be calculated. In addition, a threshold is set so that the threshold can be used to exclude a color having a local maximum that is not higher than the threshold from the representative colors. In this case, a small local maximum which is produced by noise, for example, can be eliminated so that increase in the number of colors can be avoided. Further, an instruction to designate the kind of colors may be given. In this case, a plane to separate the representative color for the designated kind of colors in the color space can be calculated.

According to the embodiment, colors of extracted document elements are set up. On the basis of the set up colors, particular ones of presumed representative colors are separated in the color space. Then, all the pixels existing in regions surrounded by a calculated binarization plane and calculated separation planes are substituted with representative colors of the corresponding regions. This makes it possible to appropriately substitute the pixels of the document image with set-up representative colors. By the substitution, effective color subtraction processing can be performed so as not to impair visibility. Consequently, a document image can be created with the number of colors subtracted in compression processing at a high compression ratio.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A document image processing system comprising:
an input portion to input a document image;
an extraction portion to extract document elements of the document image from pixels of the inputted document image;
a presumption portion to presume representative colors of the extracted document elements in a color space;
a calculation portion to calculate a plane to separate the presumed representative colors in the color space; and
a substitution portion to substitute colors of the pixels of each of the document elements existing in a region separated by the calculated plane in the color space with each of the representative colors existing in the same region.

2. The document image processing system according to claim 1, wherein
the extraction portion extracts a first region including a background and second regions respectively including the document elements from the pixels of the document image, on the basis of a binarization threshold associated with a color of a background and colors of the document elements, and
the presumption portion presumes representative colors corresponding to the extracted first region and the extracted second regions respectively in the color space.

3. The document image processing system according to claim 1, wherein
the extraction portion extracts a first region including a background and second regions respectively including the document elements from the pixels of the document image, on the basis of a binarization threshold associated with a color of a background and colors of the document elements, and
the calculation portion calculates a plane to separate the extracted first region and the extracted second regions from each other in the color space.

4. The document image processing system according to claim 1, further comprising:
a set-up portion to set up a color of at least one of the extracted document elements, wherein
the calculation portion calculates a plane to separate particular one of the presumed representative colors from the other presumed representative colors in the color space, on the basis of the set-up color.

5. A document image processing system comprising:
an input portion to input a document image data of a color document on which a character and an image other than the character are displayed;
an extraction portion to extract a plurality of document elements including the character and the image other than the character from binary pixels of the document image data;
a presumption portion to presume a region of a background and regions of the document elements from the binary pixels of the document image data on the basis of a binarization plane associated with a color of the background and colors of the pixels of the document elements, and to presume a representative color of each of the document elements in a color space;
a calculation portion to calculate separation planes to separate the representative colors from each other in the color space; and
a substitution portion to substitute colors of pixels corresponding to each separation region with each of the representative colors existing in the same separation region, the separation region being surrounded by at least one of the separation planes and the binarization plane.

6. The document image processing system according to claim 5, wherein
the presumption portion creates a frequency distribution of a background color and a plurality of frequency distributions of the document elements in the color space,
the presumption portion presumes a local maximum of each of the frequency distributions as a representative color,
the presumption portion acquires a plurality of representative vectors drawn from the representative color of the frequency distribution of the background color to the representative colors of the plurality of frequency distributions, and
the calculation portion calculates the separation planes on the basis of directional vectors each drawn between the plurality of representative vectors.

7. A document image processing method comprising:
inputting pixels of a document image;
extracting document elements of the document image from the inputted pixels of the document image;
presuming representative colors of the extracted document element in a color space;
calculating planes to separate the presumed representative colors in the color space; and
substituting colors of the pixels of each of the document elements existing in each separation region of the color space with each of the representative color existing in the same separation region, the separation region being separated by at least one of the calculated planes.

8. A document image processing method comprising:
inputting document image data of a color document on which a character and an image other than the character are displayed;
extracting a plurality of document elements including the character and the image other than the character, from binary pixels of the document image data;
presuming a region of a background and regions of the document elements from pixels of the document image data, on the basis of a binarization plane associated with a color of the background and a color of the character;
presuming a representative color of each of the document elements corresponding to each of the regions of the document elements in a color space;
calculating separation planes to separate the representative colors from each other in the color space; and
substituting colors of pixels in each separation region with the representative color existing in the same separation region, the separation region being surrounded by at least one of the separation planes and the binarization plane.

9. A program for processing document image which is executed by a computer, comprising:
inputting document image data of a color document on which a character and an image other than the character are displayed;
extracting a plurality of document elements including the character and the image other than the character, from binary pixels of the document image data;
presuming a region of a background and regions of the document elements from pixels of the document image data, on the basis of a binarization plane associated with a color of the background and a color of the character;
presuming a representative color of each of the document elements corresponding to each of the regions of the document elements in a color space;
calculating separation planes to separate the representative colors from each other in the color space; and
substituting colors of pixels in each separation region with the representative color existing in the same separation region, the separation region being surrounded by at least one of the separation planes and the binarization plane.
